(19) United States
(12) Patent Application Publication
(10) Pub. No.: US 2025/0103728 A1
(43) Pub. Date: Mar. 27, 2025

(54) INFORMATION PRESENTING APPARATUS, INFORMATION PRESENTING METHOD, AND COMPUTER-READABLE RECORDING MEDIUM

(71) Applicant: NEC Corporation, Tokyo (JP)

(72) Inventor: Yunosuke Urakawa, Tokyo (JP)

(73) Assignee: NEC Corporation, Tokyo (JP)

(21) Appl. No.: 18/822,761

(22) Filed: Sep. 3, 2024

(30) Foreign Application Priority Data
Sep. 25, 2023 (JP) 2023-160717

(51) Int. Cl. G06F 21/57

(52) U.S. Cl. CPC G06F 21/577; G06F 2221/034

(57) ABSTRACT

An information presenting apparatus obtains first similarities between first vulnerability information indicating a vulnerability of a target system and a plurality of pieces of second vulnerability information indicating vulnerabilities of computer systems, the plurality of pieces of second vulnerability being prepared in advance, extracts a piece of the second vulnerability information with which the obtained first similarity is in a set range, obtains second similarities between first system information including an index indicating performance of the target system and a plurality of pieces of second system information including indices indicating performance of the computer systems, the plurality of pieces of second system information being prepared in advance, extracts a piece of the second system information with which the obtained second similarity is in a set range, and generates presentation information for presentation using the extracted piece of the second vulnerability information and the extracted piece of the second system information.

### CROSS-REFERENCE TO RELATED APPLICATION

This application is based upon and claims the benefit of priority from Japanese patent application No. 2023-160717, filed on Sep. 25, 2023, the disclosure of which is incorporated herein in its entirety by reference.

### BACKGROUND OF THE INVENTION

### 1. Field of the Invention

The present disclosure relates to an information presenting apparatus and an information presenting method for presenting information regarding a method of handling vulnerability of computer systems, and further relates to a computer-readable recording medium having recorded thereon a program for realizing the apparatus and method.

### 2. Background Art

In recent years, cyber-attacks targeting computer systems in corporations, government offices, and the like are causing increasing damage, such as information leakage and suspension of business. Therefore, corporations, government offices, and the like are required to have computer systems robust to cyber-attacks. For example, Patent Document 1 discloses a system for supporting a security design of computer systems.

The system disclosed in Patent Document 1 first checks the characteristics of vulnerabilities in a target system against a database that stores countermeasure policies against cyber-attacks, and identifies a vulnerability whose characteristics are similar to that vulnerability. Next, the system disclosed in Patent Document 1 identifies a frequently used countermeasure policy out of countermeasure policies associated with the identified vulnerability, and presents the identified countermeasure policy to a system administrator or the like.

According to the system disclosed in Patent Document 1, an administrator or the like of a target system can handle the vulnerability of the target system and understand the countermeasure assumed to be optimal. It is thus considered that the disclosed system can make the target system robust to cyber-attacks.
Patent Document 1: Japanese Patent Laid-Open Publication No. 2016-045736

However, in Patent Document 1, the countermeasure policy against the vulnerability of the target system is determined only by the preset association and use frequency. A computer system is commonly constituted by many constituent components, and its configuration is often changed. The optimal countermeasure policy is thus not fixed. Therefore, the system disclosed in Patent Document 1 may not present an optimal countermeasure policy for the target system, and may not be able to present optimal security countermeasures.

### SUMMARY OF INVENTION

An example object of the present disclosure is to solve the aforementioned problem and present a method of handling vulnerability corresponding to the configuration of a computer system that is the target.

In order to achieve the above-described object, an information presenting apparatus according to an example aspect of the present disclosure includes:
a vulnerability information extracting unit configured to obtain similarities, as first similarities, between first vulnerability information indicating a vulnerability of a target system and a plurality of pieces of second vulnerability information indicating vulnerabilities of computer systems, the plurality of pieces of second vulnerability being prepared in advance, and extract a piece of the second vulnerability information with which the obtained first similarity is in a set range;
a system information extracting unit configured to obtain similarities, as second similarities, between first system information including an index indicating performance of the target system and a plurality of pieces of second system information including indices indicating performance of the computer systems, the plurality of pieces of second system information being prepared in advance, and extract a piece of the second system information with which the obtained second similarity is in a set range; and
a presentation information generating unit configured to generate presentation information for presentation using the extracted piece of the second vulnerability information and the extracted piece of the second system information.

In order to achieve the above-described object, an information presenting method according to an example aspect of the present disclosure includes:
a vulnerability information extracting step of obtaining similarities, as first similarities, between first vulnerability information indicating a vulnerability of a target system and a plurality of pieces of second vulnerability information indicating vulnerabilities of computer systems, the plurality of pieces of second vulnerability being prepared in advance, and extracting a piece of the second vulnerability information with which the obtained first similarity is in a set range;
a system information extracting step of obtaining similarities, as second similarities, between first system information including an index indicating a performance of the target system and a plurality of pieces of second system information including indices indicating performances of the computer systems, the plurality of pieces of second system information being prepared in advance, and extracting a piece of the second system information with which the obtained second similarity is in a set range; and
a presentation information generating step of generating presentation information for presentation using the extracted piece of the second vulnerability information and the extracted piece of the second system information.

In order to achieve the above-described object, a computer readable recording medium according to an example aspect of the present disclosure is a computer readable recording medium that includes recorded thereon a program,
a vulnerability information extracting step of obtaining similarities, as first similarities, between first vulnerability information indicating a vulnerability of a target system and a plurality of pieces of second vulnerability information indicating vulnerabilities of computer systems, the plurality of pieces of second vulnerability being prepared in advance, and extracting a piece of the second vulnerability information with which the obtained first similarity is in a set range;
a system information extracting step of obtaining similarities, as second similarities, between first system information including an index indicating a performance of the target system and a plurality of pieces of second system information including indices indicating performances of the computer systems, the plurality of pieces of second system information being prepared in advance, and extracting a piece of the second system information with which the obtained second similarity is in a set range; and
a presentation information generating step of generating presentation information for presentation using the extracted piece of the second vulnerability information and the extracted piece of the second system information.

As described above, according to the present discloser, it is possible to present a method of handling vulnerability corresponding to the configuration of a computer system that is the target.

### BRIEF DESCRIPTION OF THE DRAWINGS

FIG. 1 is a configuration diagram illustrating a schematic configuration of an example of the information presenting apparatus.

FIG. 2 is a configuration diagram illustrating a specific configuration of an example of the information presenting apparatus.

FIG. 3 is a diagram illustrating an example of the vulnerability information.

FIG. 4 is a diagram for describing the method of calculating the similarities between the first vulnerability information and the second vulnerability information.

FIG. 5 is a diagram illustrating an example of the system information.

FIG. 6 is a diagram for describing the method of calculating the similarities between the first system information and the second system information.

FIG. 7 is a diagram illustrating an example of the vulnerability handling information.

FIG. 8 is a diagram illustrating an example of the presentation information.

FIG. 9 is a flow diagram illustrating an example of the operations of the information presenting apparatus.

FIG. 10 is a block diagram illustrating an example of a computer that realizes the information presenting apparatus.

### EXAMPLE EMBODIMENT

### Example Embodiment

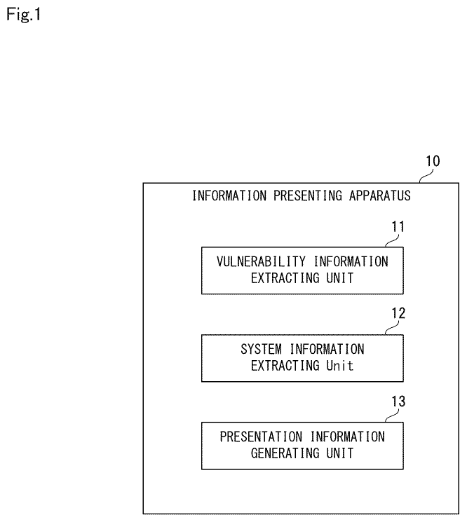

Hereinafter, an example of an information presenting apparatus will be described in an example embodiment with reference to FIGS. 1 to 10.

### [Apparatus Configuration]

First, a schematic configuration of an example of the information presenting apparatus will be described with reference to FIG. 1. FIG. 1 is a configuration diagram illustrating a schematic configuration of an example of the information presenting apparatus.

An information presenting apparatus 10 illustrated in FIG. 1 is an apparatus for presenting information regarding a method of handling vulnerability of a computer system. As illustrated in FIG. 1, the information presenting apparatus 10 includes a vulnerability information extracting unit 11, a system information extracting unit 12, and a presentation information generating unit 13.

The vulnerability information extracting unit 11 first obtains the similarity between first vulnerability information and second vulnerability information as a first similarity. The first vulnerability information is information indicating the vulnerability of a computer system (hereinafter referred to as a “target system”) to which the information is to be presented. A plurality of pieces of the second vulnerability information are prepared in advance, and indicate vulnerabilities of computer systems. The vulnerability information extracting unit 11 also extracts pieces of second vulnerability information with which the obtained first similarity is in a set range.

The system information extracting unit 12 first obtains the similarity between first system information and second system information as a second similarity. The first system information is information including an index indicating the performance of the target system. A plurality of pieces of the second system information are prepared in advance, and include indices indicating performance of computer systems. The system information extracting unit 12 also extracts pieces of second system information with which the obtained second similarity is in a set range.

The presentation information generating unit 13 generates presentation information to be presented using the pieces of second vulnerability information extracted by the vulnerability information extracting unit 11 and the pieces of second system information extracted by the system information extracting unit 12.

As described above, the information presenting apparatus 10 extracts a piece of vulnerability information applicable to the target system from existing pieces of vulnerability information and a piece of system information applicable to the target system from existing pieces of system information, and generates information to be presented using the extracted information. Therefore, the information presenting apparatus 10 can present a method of handling vulnerability corresponding to the configuration of the target system.

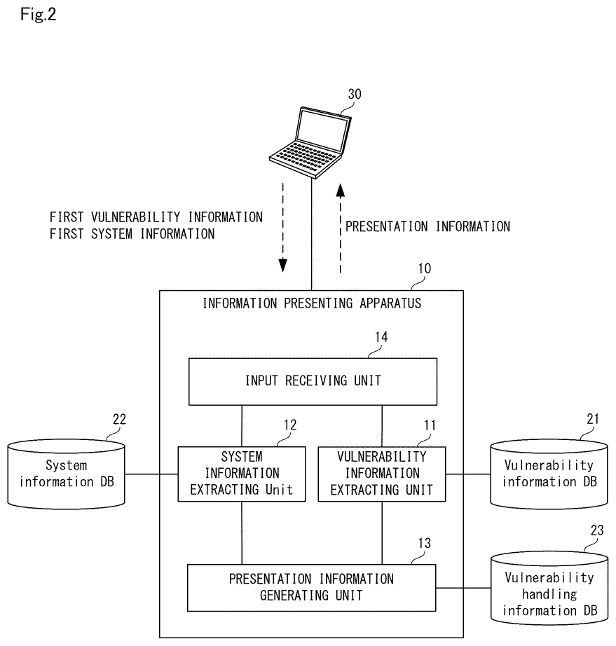

Next, the configuration and functions of the information presenting apparatus 10 will be specifically described using FIGS. 2 to 8. FIG. 2 is a configuration diagram illustrating a specific configuration of an example of the information presenting apparatus.

As illustrated in FIG. 2, the information presenting apparatus 10 is connected to a terminal apparatus 30 of a user via a network or the like. The information presenting apparatus 10 is also connected to a vulnerability information database 21, a system information database 22, and a vulnerability handling information database 23 via a network or the like. Note that, hereinafter, the database is also denoted as “DB”. Each database may also be constructed within the information presenting apparatus 10.

As illustrated in FIG. 2, the information presenting apparatus 10 includes an input receiving unit 14 in addition to the aforementioned vulnerability information extracting unit 11, system information extracting unit 12, and presentation information generating unit 13. The input receiving unit 14 receives input of the first vulnerability information and the first system information.

Specifically, when a user inputs first vulnerability information and first system information on the terminal apparatus 30, the terminal apparatus 30 transmits the input first vulnerability information and first system information to the information presenting apparatus 10. The input receiving unit 14 receives the transmitted first vulnerability information and first system information.

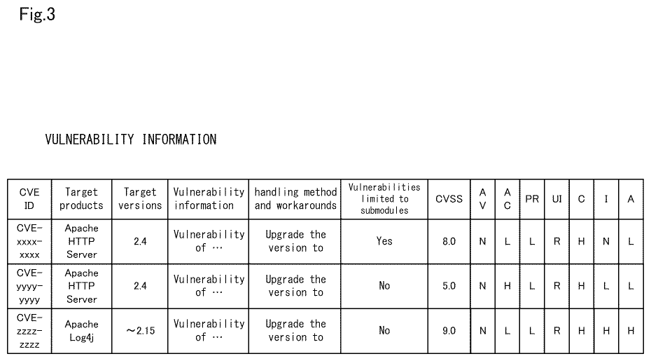

The first vulnerability information and the second vulnerability information are each constituted by a plurality of elements indicating vulnerabilities. Hereinafter, when referring to both the first vulnerability information and the second vulnerability information, they are collectively referred to as “vulnerability information”. FIG. 3 is a diagram illustrating an example of the vulnerability information.

In the example embodiment, the vulnerability information is information indicating a vulnerability managed using CVE (Common Vulnerabilities and Exposures), as illustrated in FIG. 3. A CVE ID is assigned to each piece of vulnerability information. The numbering and registration of the CVE ID is performed by MITRE.

In the example embodiment, a user can input a CVE ID as the first vulnerability information on the terminal apparatus 30. The vulnerability information database 21 stores many pieces of vulnerability information illustrated in FIG. 3.

In the example embodiment, the vulnerability information extracting unit 11 checks the CVE ID input by the user against the vulnerability information database 21, and acquires the corresponding vulnerability information as the first vulnerability information. Next, the vulnerability information extracting unit 11 sets, as the second vulnerability information, a piece of vulnerability information that are not acquired from the vulnerability information database 21, and vectorizes the first vulnerability information and the second vulnerability information.

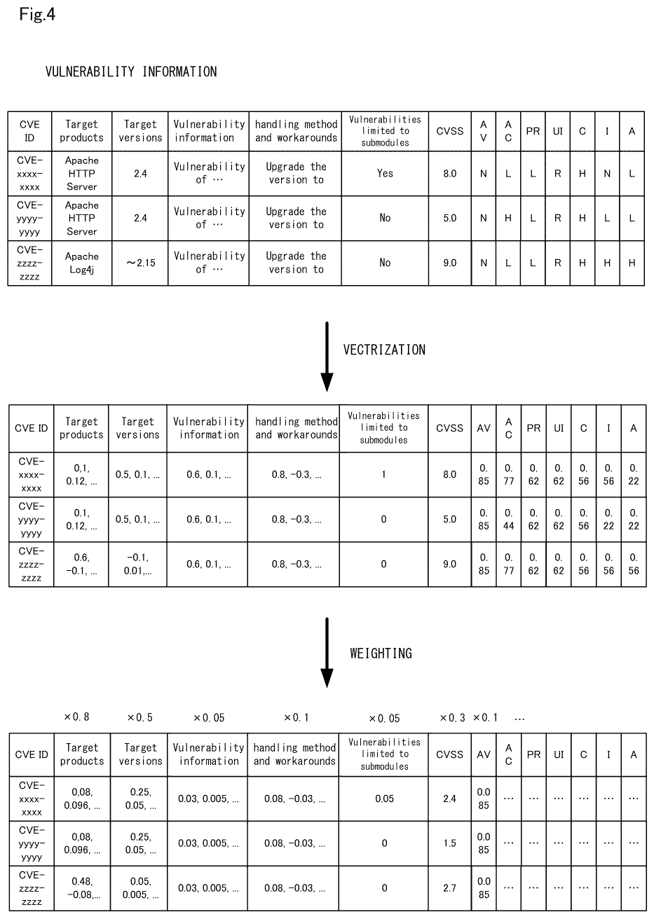

Furthermore, the vulnerability information extracting unit 11 obtains the similarities between the first vulnerability information and the second vulnerability information using the vectorized first vulnerability information, the vectorized second vulnerability information, and preset weights. FIG. 4 is a diagram for describing the method of calculating the similarities between the first vulnerability information and the second vulnerability information.

Specifically, the vulnerability information extracting unit 11 converts all of the elements that constitute the vulnerability information into numerical values, as illustrated in a middle section in FIG. 4. In this case, regarding the elements that are originally represented by numerical values, these numerical values are used. The elements that are represented by letters such as “YES”, “N”, and “L” are converted into numerical values according to a preset rule. Sentences are converted into numerical values using an existing vectorization technique such as Doc2Vec. Note that the vectorization technique is not specifically limited.

As illustrated in a lower section in FIG. 4, the vulnerability information extracting unit 11 also multiplies each element by a weight that is preset for the respective elements. The vulnerability information extracting unit 11 then vectorizes the vulnerability information by constructing a vector constituted by the multiplied elements.

Furthermore, the vulnerability information extracting unit 11 calculates, as the similarities, cosine similarities between the first vulnerability information vector and the second vulnerability information vectors that are obtained as described above. Thereafter, the vulnerability information extracting unit 11 extracts second vulnerability information regarding which the cosine similarity is greater than or equal to a threshold, for example. Note that a corresponding CVE ID is extracted as the second vulnerability information. A similarity other than the cosine similarity may alternatively be calculated as the aforementioned similarity.

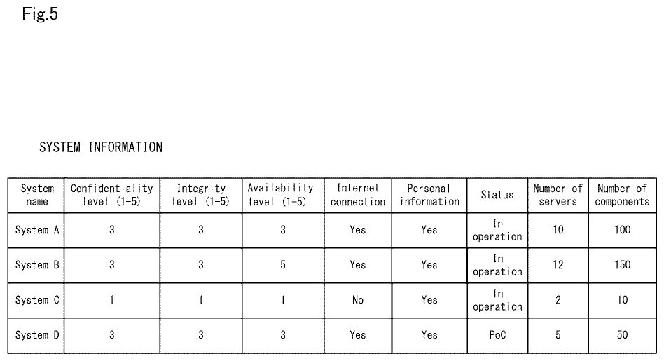

In the example embodiment, the first system information and the second system information are each information including at least an index indicating the confidentiality of a computer system, an index indicating the integrity of the computer system, and an index indicating the availability of the computer system. Hereinafter, when referring to both the first system information and second system information, they are collectively referred to as “system information”. FIG. 5 is a diagram illustrating an example of the system information.

In the example embodiment, the system information is set for each computer system (system name), as illustrated in FIG. 5. The system information includes a confidentiality level indicating the confidentiality of a computer system, an integrity level indicating the integrity of the computer system, and an availability level indicating the availability of the computer system, and these levels indicate the performance of the computer system. The system information may also include information regarding whether or not the internet connection is established, whether or not personal information is present, the status, the number of servers, the number of constituent products, and the like. The information included in the system information is not limited to the above types of information.

In the example in FIG. 5, the confidentiality level, the integrity level, and the availability level are each set by an administrator or the like of the computer system according to preset criteria. A user can input a system name of the target system as the first system information on the terminal apparatus 30. The system information database 22 stores many pieces of system information illustrated in FIG. 5.

In the example embodiment, the system information extracting unit 12 checks the system name input by the user against the system information database 22 and acquires corresponding system information as the first system information. Next, the system information extracting unit 12 sets, as the second system information, pieces of system information that have not been acquired from the system information database 22, and vectorizes the first system information and the second system information.

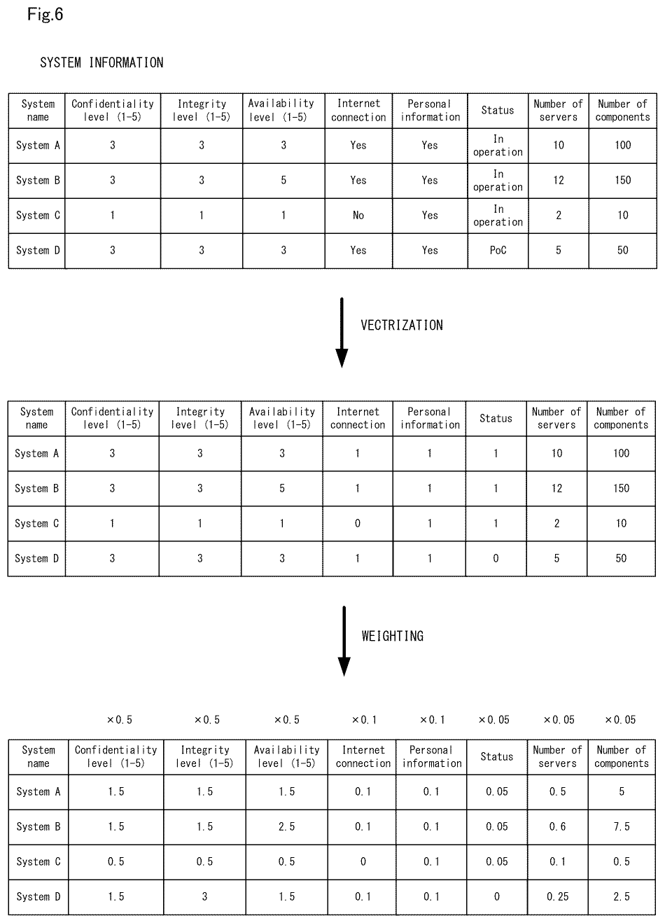

Furthermore, the system information extracting unit 12 obtains the similarities between the first system information and the second system information using the vectorized first system information, the vectorized second system information, and preset weights. FIG. 6 is a diagram for describing the method of calculating the similarities between the first system information and the second system information.

Specifically, the system information extracting unit 12 converts all of the elements that constitute the system information into numerical values, as illustrated in a middle section in FIG. 6. In this case as well, regarding the elements that are originally represented by numerical values, these numerical values are used. The elements that are represented by letters such as “Present”, “Not Present”, and “In Operation” are converted into numerical values according to a preset rule.

The system information extracting unit 12 multiplies each element by a weight that is preset for the respective elements, as illustrated in a lower section in FIG. 6. Then, the system information extracting unit 12 vectorizes the system information by constructing a vector constituted by the multiplied elements.

Furthermore, the system information extracting unit 12 calculates, as the similarities, cosine similarities between the first system information vector and the second system information vectors that are obtained as described above. Thereafter, the system information extracting unit 12 extracts second system information regarding which the cosine similarity is greater than or equal to a threshold, for example. Note that a similarity other than the cosine similarity may alternatively be calculated as the aforementioned similarity.

In the example embodiment, the presentation information generating unit 13 first identifies a computer system corresponding to the second system information extracted by the system information extracting unit 12. Furthermore, the presentation information generating unit 13 identifies, for the specified computer system, a first handling method for the vulnerability indicated by the first vulnerability information and a second handling method of the vulnerability indicated by the extracted second vulnerability information. The presentation information generating unit 13 then generates presentation information using the identified first handling method and second handling method.

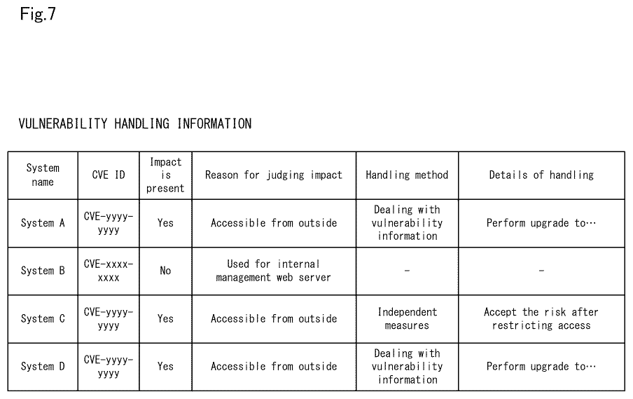

Specifically, the presentation information generating unit 13 identifies the first handling method and second handling method using vulnerability handling information stored in the vulnerability handling information database 23. FIG. 7 is a diagram illustrating an example of the vulnerability handling information.

As illustrated in FIG. 7, the vulnerability handling information database 23 stores vulnerability handling information for each combination of the computer system and the CVE ID. The vulnerability handling information is constituted by pieces of information such as a system name of the computer system, a CVE ID, whether or not impact is present, a reason for judging the impact, a handling method, and details of handling. The vulnerability handling information is created by an administrator of each computer system or the like based on information regarding the past handling.

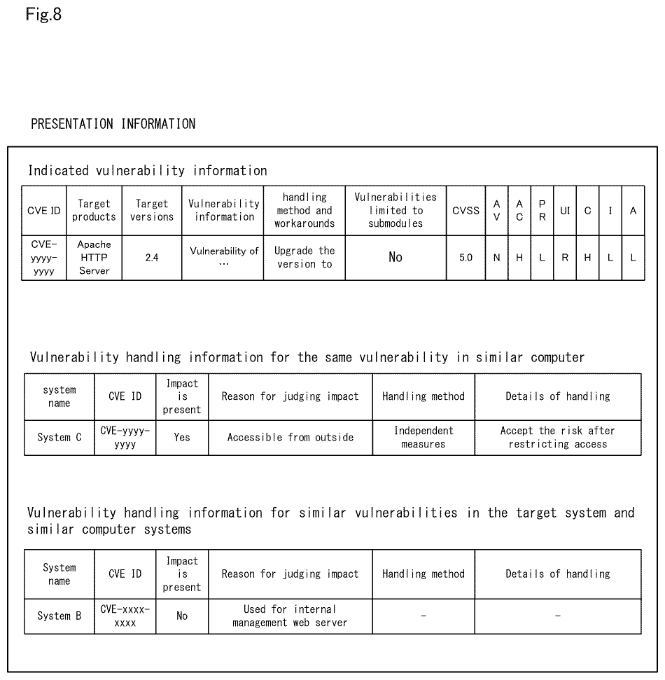

Assume that, for example, the CVE ID input by a user as the first vulnerability information is “CVE-yyyy-yyyy” (refer to FIG. 3) and the target system is “System A” (refer to FIG. 5), as illustrated in an upper section of FIG. 8. Also assume that the vulnerability information extracting unit 11 has extracted “CVE-xxxx-xxxx” as the second vulnerability information with which the first similarity is in a set range. Furthermore, assume that the system information extracting unit 12 has extracted pieces of system information regarding “System B” and “System C” as the second system information with which the second similarity is in a set range.

In this case, the presentation information generating unit 13 first acquires, with respect to “System B” and “System C”, vulnerability handling information regarding “CVE-yyyy-yyyy” from the vulnerability handling information database 23. In the example in FIG. 8, vulnerability handling information regarding “System C” is acquired (refer to FIG. 7).

Furthermore, the presentation information generating unit 13 also acquires, with respect to “System B” and “System C”, vulnerability handling information regarding “CVE-xxxx-xxxx” from the vulnerability handling information database 23. In the example in FIG. 8, vulnerability handling information regarding “System B” is acquired (refer to FIG. 7). When vulnerability handling information regarding similar “CVE-xxxx-xxxx” is stored for “System A”, which is the target system, in the vulnerability handling information database 23, the presentation information generating unit 13 can also acquire this vulnerability handling information.

Thereafter, the presentation information generating unit 13 generates presentation information using the acquired pieces of vulnerability handling information, and transmits the generated presentation information to the terminal apparatus 30. Accordingly, the presentation information illustrated in FIG. 8 is displayed on a screen of the terminal apparatus 30. FIG. 8 is a diagram illustrating an example of the presentation information.

### [Apparatus Operations]

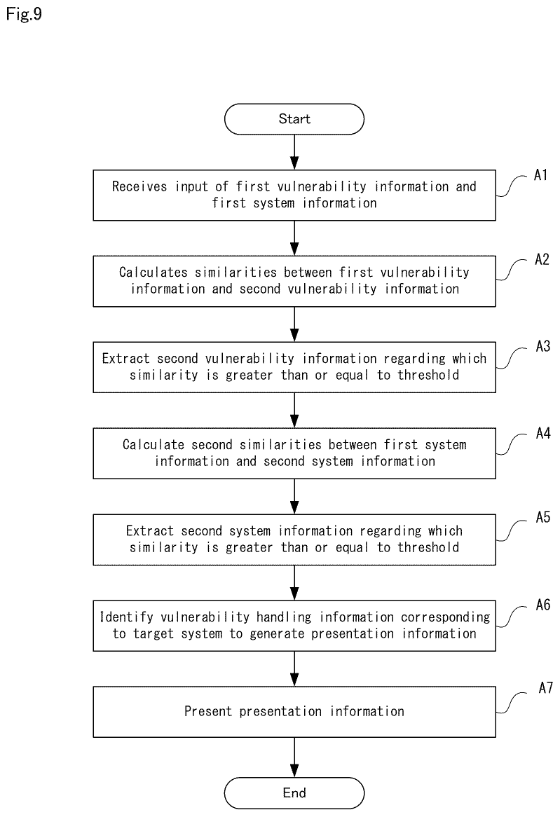

Next, operations of the information presenting apparatus 10 will be described with reference to FIG. 9. FIG. 9 is a flow diagram illustrating an example of the operations of the information presenting apparatus. In the following description, FIGS. 1 to 8 will be referred to as appropriate. In the example embodiment, an information presenting method is implemented by operating the information presenting apparatus 10. Therefore, the following description of the operations of the information presenting apparatus 10 replaces the description of the information presenting method.

First, it is assumed that a user has input a CVE ID as the first vulnerability information on the terminal apparatus 30, and has input a system name as the first system information. In response to this, the terminal apparatus 30 transmits the input first vulnerability information and first system information to the information presenting apparatus 10.

Then, the input receiving unit 14 receives the input of the first vulnerability information and first system information (step A1), as illustrated in FIG. 9.

Next, the vulnerability information extracting unit 11 calculates the similarities between the first vulnerability information received in step A1 and the second vulnerability information 10) stored in the vulnerability information database 21 (step A2).

Next, the vulnerability information extracting unit 11 extracts a piece of second vulnerability information regarding which the similarity calculated in step A2 is greater than or equal to a threshold (step A3).

Next, the system information extracting unit 12 calculates the similarities, as second similarities, between the first system information received in step A1 and the second system information stored in the system information database 22 (step A4).

Next, the system information extracting unit 12 extracts second system information regarding which the similarity calculated in step A4 is greater than or equal to a threshold (step A5).

Note that steps A4 and A5 may be executed prior to steps A2 and A3. Alternatively, steps A4 and A5 may be executed at the same time as steps A2 and A3.

Next, the presentation information generating unit 13 identifies vulnerability handling information corresponding to the handling method for the target system from the vulnerability handling information database 23 using the second vulnerability information extracted in step A3 and the second system information extracted in step A5. The presentation information generating unit 13 then generates presentation information using the identified vulnerability handling information (step A6).

Thereafter, the presentation information generating unit 13 transmits the presentation information generated in step A6 to the terminal apparatus 30, and causes the terminal apparatus to display the presentation information (step A7).

As described above, in the example embodiment, the information presenting apparatus 10 extracts a vulnerability similar to the vulnerability designated regarding the target system. The information presenting apparatus 10 also extracts a computer system similar to the target system. The information presenting apparatus 10 then identifies optimal vulnerability handling information from pieces of vulnerability handling information prepared in advance using the extracted vulnerability and computer system as a clue, and presents the identified optimal vulnerability handling information. Therefore, the information presenting apparatus 10 can present a vulnerability handling method corresponding to the configuration of the target system.

In the example embodiment, in particular when judging similarity between the target system and other computer systems, the confidentiality level, integrity level, and availability level of each system are used as indices for the judgement. Accordingly, judgement regarding similarity can be executed with exceptional accuracy.

### [Program]

A program in the example embodiment need only be a program for causing a computer to perform steps A1 to A7 illustrated in FIG. 9. The information presenting apparatus 10 and information presenting method according to the example embodiment can be realized by installing this program on a computer and executing the program. In this case, a processor of the computer functions as the vulnerability information extracting unit 11, the system information extracting unit 12, the presentation information generating unit 13, and the input receiving unit 14, and performs processing. Specific examples of the computer include a smartphone and a tablet terminal device in addition to a general-purpose PC.

The program according to the present example embodiment may also be executed by a computer system that includes a plurality of computers. In this case, for example, each of the 20) computers may function as any of the vulnerability information extracting unit 11, the system information extracting unit 12, the presentation information generating unit 13, and the input receiving unit 14.

### [Physical Configuration]

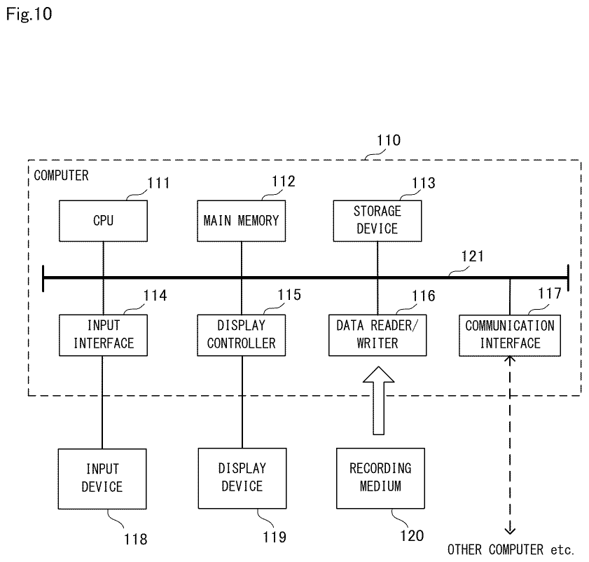

Using FIG. 10, the following describes a computer that realizes the information presenting apparatus 10 by executing the program according to the example embodiment. FIG. 10 is a block diagram illustrating an example of a computer that realizes the information presenting apparatus.

As shown in FIG. 10, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the example embodiment may be distributed over the Internet connected via the communication interface 117.

Also, specific examples of the storage device 113 include a hard disk drive and a 10) semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that he information presenting apparatus 10 can also be realized by using items of hardware, for example, electric circuit that respectively correspond to the components rather than the computer in which the program is installed. Furthermore, a part of he information presenting apparatus 10 may be realized by the program, and the remaining part of he information presenting apparatus 10 may be realized by hardware. In the example embodiment, the computer is not limited to the computer illustrated in FIG. 10.

A part or an entirety of the above-described example embodiment can be represented by (Supplementary Note 1) to (Supplementary Note 18) described below but is not limited to the description below.

### (Supplementary Note 1)

An information presenting apparatus comprising:
a vulnerability information extracting unit configured to obtain similarities, as first similarities, between first vulnerability information indicating a vulnerability of a target system and a plurality of pieces of second vulnerability information indicating vulnerabilities of computer systems, the plurality of pieces of second vulnerability being prepared in advance, and extract a piece of the second vulnerability information with which the obtained first similarity is in a set range;
a system information extracting unit configured to obtain similarities, as second similarities, between first system information including an index indicating performance of the target system and a plurality of pieces of second system information including indices indicating performance of the computer systems, the plurality of pieces of second system information being prepared in advance, and extract a piece of the second system information with which the obtained second similarity is in a set range; and
a presentation information generating unit configured to generate presentation information for presentation using the extracted piece of the second vulnerability information and the extracted piece of the second system information.

### (Supplementary Note 2)

The information presenting apparatus according to claim 1,
wherein the first system information and the second system information at least include an index indicating confidentiality of a computer system, an index indicating integrity of the computer system, and an index indicating an availability of the computer system.

### (Supplementary Note 3)

The information presenting apparatus according to claim 2,
wherein the system information extracting unit vectorizes the first system information and the second system information, and obtains a similarity between the first system information and the second system information using the vectorized first system information, the vectorized second system information, and a preset weight.

### (Supplementary Note 4)

The information presenting apparatus according to claim 1,
wherein the first vulnerability information and the second vulnerability information are each constituted by a plurality of elements indicating a vulnerability, and
the vulnerability information extracting unit vectorizes the first vulnerability information and the second vulnerability information, and obtains a similarity between the first vulnerability information and the second vulnerability information using the vectorized first vulnerability information, the vectorized second vulnerability information, and a preset weight.

### (Supplementary Note 5)

The information presenting apparatus according to claim 1,
wherein the presentation information generating unit identifies a computer system corresponding to the extracted second system information, further identifies, for the identified computer system, a first handling method of handling the vulnerability indicated by the first vulnerability information and a second handling method of handling the vulnerability indicated by the extracted second vulnerability information, and generates the presentation information using the identified first handling method and second handling method.

### (Supplementary Note 6)

The information presenting apparatus according to claim 1, further comprising:
an input information receiving unit configured to receive input of the first vulnerability information and the first system information.

### (Supplementary Note 7)

An information presenting method comprising:
obtaining similarities, as first similarities, between first vulnerability information indicating a vulnerability of a target system and a plurality of pieces of second vulnerability information indicating vulnerabilities of computer systems, the plurality of pieces of second vulnerability being prepared in advance, and extracting a piece of the second vulnerability information with which the obtained first similarity is in a set range;
obtaining similarities, as second similarities, between first system information including an index indicating a performance of the target system and a plurality of pieces of second system information including indices indicating performances of the computer systems, the plurality of pieces of second system information being prepared in advance, and extracting a piece of the second system information with which the obtained second similarity is in a set range; and
generating presentation information for presentation using the extracted piece of the second vulnerability information and the extracted piece of the second system information.

### (Supplementary Note 8)

The information presenting method according to claim 7,
wherein the first system information and the second system information at least include an index indicating confidentiality of a computer system, an index indicating integrity of the computer system, and an index indicating an availability of the computer system.

### (Supplementary Note 9)

The information presenting method according to claim 8,
Wherein, in the system information extracting, vectorizing the first system information and the second system information, and obtaining a similarity between the first system information and the second system information using the vectorized first system information, the vectorized second system information, and a preset weight.

### (Supplementary Note 10)

The information presenting method according to claim 7,
wherein the first vulnerability information and the second vulnerability information are each constituted by a plurality of elements indicating a vulnerability, and
in the vulnerability information extracting, vectorizing the first vulnerability information and the second vulnerability information, and obtaining a similarity between the first vulnerability information and the second vulnerability information using the vectorized first vulnerability information, the vectorized second vulnerability information, and a preset weight.

### (Supplementary Note 11)

The information presenting method according to claim 7,
Wherein, in the presentation information generating, identifying a computer system corresponding to the extracted second system information, further identifying, for the identified computer system, a first handling method of handling the vulnerability indicated by the first vulnerability information and a second handling method of handling the vulnerability indicated by the extracted second vulnerability information, and generating the presentation information using the identified first handling method and second handling method.

### (Supplementary Note 12)

The information presenting method according to claim 7, further comprising:
receiving input of the first vulnerability information and the first system information.

### (Supplementary Note 13)

A computer-readable recording medium that includes a program including instructions recorded thereon, the instructions causing a computer to carry out:
obtaining similarities, as first similarities, between first vulnerability information indicating a vulnerability of a target system and a plurality of pieces of second vulnerability information indicating vulnerabilities of computer systems, the plurality of pieces of second vulnerability being prepared in advance, and extracting a piece of the second vulnerability information with which the obtained first similarity is in a set range;
obtaining similarities, as second similarities, between first system information including an index indicating a performance of the target system and a plurality of pieces of second system information including indices indicating performances of the computer systems, the plurality of pieces of second system information being prepared in advance, and extracting a piece of the second system information with which the obtained second similarity is in a set range; and
generating presentation information for presentation using the extracted piece of the second vulnerability information and the extracted piece of the second system information.

### (Supplementary Note 14)

The computer-readable recording medium according to claim 13,
wherein the first system information and the second system information at least include an index indicating confidentiality of a computer system, an index indicating integrity of the computer system, and an index indicating an availability of the computer system.

### (Supplementary Note 15)

The computer-readable recording medium according to claim 14,
wherein, in the system information extracting, vectorizing the first system information and the second system information, and obtaining a similarity between the first system information and the second system information using the vectorized first system information, the vectorized second system information, and a preset weight.

### (Supplementary Note 16)

The computer-readable recording medium according to claim 13,
wherein the first vulnerability information and the second vulnerability information are each constituted by a plurality of elements indicating a vulnerability, and
in the vulnerability information extracting, vectorizing the first vulnerability information and the second vulnerability information, and obtaining a similarity between the first vulnerability information and the second vulnerability information using the vectorized first vulnerability information, the vectorized second vulnerability information, and a preset weight.

### (Supplementary Note 17)

The computer-readable recording medium according to claim 13,
wherein, in the presentation information generating, identifying a computer system corresponding to the extracted second system information, further identifying, for the identified computer system, a first handling method of handling the vulnerability indicated by the first vulnerability information and a second handling method of handling the vulnerability indicated by the extracted second vulnerability information, and generating the presentation information using the identified first handling method and second handling method.

### (Supplementary Note 18)

The computer-readable recording medium according to claim 13,
the program further including instructions that causes the computer to carry out:
receiving input of the first vulnerability information and the first system information.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

According to the present discloser, it is possible to present a method of handling vulnerability corresponding to the configuration of a computer system that is the target. The present disclosure is useful in the field of security design of computer systems.

### REFERENCE SIGNS LIST

10 Information presenting apparatus
11 Vulnerability information extracting unit
12 System information extracting unit
13 presentation information generating unit
14 Input receiving unit
21 Vulnerability information database
22 System information database
23 Vulnerability handling information database
30 Terminal apparatus
100 Computing system
101 Attack command database
102 Solution template database
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An information presenting apparatus comprising:
at least one memory storing instructions; and
at least one processor configured to execute the instructions to:
obtain similarities, as first similarities, between first vulnerability information indicating a vulnerability of a target system and a plurality of pieces of second vulnerability information indicating vulnerabilities of computer systems, the plurality of pieces of second vulnerability being prepared in advance, and extract a piece of the second vulnerability information with which the obtained first similarity is in a set range;
obtain similarities, as second similarities, between first system information including an index indicating performance of the target system and a plurality of pieces of second system information including indices indicating performance of the computer systems, the plurality of pieces of second system information being prepared in advance, and extract a piece of the second system information with which the obtained second similarity is in a set range; and
generate presentation information for presentation using the extracted piece of the second vulnerability information and the extracted piece of the second system information.

2. The information presenting apparatus according to claim 1,
wherein the first system information and the second system information at least include an index indicating confidentiality of a computer system, an index indicating integrity of the computer system, and an index indicating an availability of the computer system.

3. The information presenting apparatus according to claim 2,
wherein the one or more processors further vectorizes the first system information and the second system information, and obtains a similarity between the first system information and the second system information using the vectorized first system information, the vectorized second system information, and a preset weight.

4. The information presenting apparatus according to claim 1,
wherein the first vulnerability information and the second vulnerability information are each constituted by a plurality of elements indicating a vulnerability, and
the one or more processors further vectorizes the first vulnerability information and the second vulnerability information, and obtains a similarity between the first vulnerability information and the second vulnerability information using the vectorized first vulnerability information, the vectorized second vulnerability information, and a preset weight.

5. The information presenting apparatus according to claim 1,
wherein the one or more processors further identifies a computer system corresponding to the extracted second system information, further identifies, for the identified computer system, a first handling method of handling the vulnerability indicated by the first vulnerability information and a second handling method of handling the vulnerability indicated by the extracted second vulnerability information, and generates the presentation information using the identified first handling method and second handling method.

6. The information presenting apparatus according to claim 1,
wherein the one or more processors further receives input of the first vulnerability information and the first system information.

7. An information presenting method comprising:
obtaining similarities, as first similarities, between first vulnerability information indicating a vulnerability of a target system and a plurality of pieces of second vulnerability information indicating vulnerabilities of computer systems, the plurality of pieces of second vulnerability being prepared in advance, and extracting a piece of the second vulnerability information with which the obtained first similarity is in a set range;
obtaining similarities, as second similarities, between first system information including an index indicating a performance of the target system and a plurality of pieces of second system information including indices indicating performances of the computer systems, the plurality of pieces of second system information being prepared in advance, and extracting a piece of the second system information with which the obtained second similarity is in a set range; and
generating presentation information for presentation using the extracted piece of the second vulnerability information and the extracted piece of the second system information.

8. The information presenting method according to claim 7,
wherein the first system information and the second system information at least include an index indicating confidentiality of a computer system, an index indicating integrity of the computer system, and an index indicating an availability of the computer system.

9. The information presenting method according to claim 8,
wherein, in the system information extracting, vectorizing the first system information and the second system information, and obtaining a similarity between the first system information and the second system information using the vectorized first system information, the vectorized second system information, and a preset weight.

10. The information presenting method according to claim 7,
wherein the first vulnerability information and the second vulnerability information are each constituted by a plurality of elements indicating a vulnerability, and
in the vulnerability information extracting, vectorizing the first vulnerability information and the second vulnerability information, and obtaining a similarity between the first vulnerability information and the second vulnerability information using the vectorized first vulnerability information, the vectorized second vulnerability information, and a preset weight.

11. The information presenting method according to claim 7,
wherein, in the presentation information generating, identifying a computer system corresponding to the extracted second system information, further identifying, for the identified computer system, a first handling method of handling the vulnerability indicated by the first vulnerability information and a second handling method of handling the vulnerability indicated by the extracted second vulnerability information, and generating the presentation information using the identified first handling method and second handling method.

12. The information presenting method according to claim 7, further comprising:
receiving input of the first vulnerability information and the first system information.

13. A non-transitory computer-readable recording medium that includes a program including instructions recorded thereon, the instructions causing a computer to carry out:
obtaining similarities, as first similarities, between first vulnerability information indicating a vulnerability of a target system and a plurality of pieces of second vulnerability information indicating vulnerabilities of computer systems, the plurality of pieces of second vulnerability being prepared in advance, and extracting a piece of the second vulnerability information with which the obtained first similarity is in a set range;
obtaining similarities, as second similarities, between first system information including an index indicating a performance of the target system and a plurality of pieces of second system information including indices indicating performances of the computer systems, the plurality of pieces of second system information being prepared in advance, and extracting a piece of the second system information with which the obtained second similarity is in a set range; and
generating presentation information for presentation using the extracted piece of the second vulnerability information and the extracted piece of the second system information.

14. The non-transitory computer-readable recording medium according to claim 13,
wherein the first system information and the second system information at least include an index indicating confidentiality of a computer system, an index indicating integrity of the computer system, and an index indicating an availability of the computer system.

15. The non-transitory computer-readable recording medium according to claim 14,
wherein, in the system information extracting, vectorizing the first system information and the second system information, and obtaining a similarity between the first system information and the second system information using the vectorized first system information, the vectorized second system information, and a preset weight.

16. The non-transitory computer-readable recording medium according to claim 13,
wherein the first vulnerability information and the second vulnerability information are each constituted by a plurality of elements indicating a vulnerability, and
in the vulnerability information extracting, vectorizing the first vulnerability information and the second vulnerability information, and obtaining a similarity between the first vulnerability information and the second vulnerability information using the vectorized first vulnerability information, the vectorized second vulnerability information, and a preset weight.

17. The non-transitory computer-readable recording medium according to claim 13,
wherein, in the presentation information generating, identifying a computer system corresponding to the extracted second system information, further identifying, for the identified computer system, a first handling method of handling the vulnerability indicated by the first vulnerability information and a second handling method of handling the vulnerability indicated by the extracted second vulnerability information, and generating the presentation information using the identified first handling method and second handling method.

18. The non-transitory computer-readable recording medium according to claim 13,
the program further including instructions that causes the computer to carry out:
receiving input of the first vulnerability information and the first system information.
